(19) United States
(12) Patent Application Publication
(10) Pub. No.: US 2026/0186296 A1
(43) Pub. Date: Jul. 2, 2026

(54) RETINAL PROJECTION DEVICE

(71) Applicant: TDK Corporation, Tokyo (JP)

(72) Inventors: Tomohito MIZUNO, Tokyo (JP); Takekazu YAMANE, Tokyo (JP); Takeshi NOJIRI, Tokyo (JP); Tetsuya SHIBATA, Tokyo (JP); Hideaki FUKUZAWA, Tokyo (JP)

(73) Assignee: TDK Corporation, Tokyo (JP)

(21) Appl. No.: 19/432,524

(22) Filed: Dec. 24, 2025

(30) Foreign Application Priority Data
Dec. 27, 2024 (JP) 2024-231824
Dec. 23, 2025 (JP) 2025-277752

(51) Int. Cl. G02B 27/00; G02B 1/00; G02B 27/01

(52) U.S. Cl. CPC G02B 27/0031; G02B 1/002; G02B 27/0172; G02B 2027/011; G02B 2027/0178

(57) ABSTRACT

A retinal projection device to be mounted on a near-eye wearable device includes: a light source that emits laser light; a movable mirror that performs scanning with the laser light; and a reflector that projects an image onto a retina of a user wearing the near-eye wearable device by reflecting the laser light having passed through the movable mirror and irradiating the retina with reflected light. The reflector includes: a reflective layer that reflects the laser light at a reflection angle that changes depending on a wavelength of the laser light and emits the laser light as the reflected light; and a phase correction layer that corrects chromatic aberration of the reflected light.

### CROSS-REFERENCE TO RELATED APPLICATION

This application claims the benefit of priority from Japanese Patent Application No. 2024-231824 filed with the Japan Patent Office on Dec. 27, 2024, the entire contents of which are incorporated herein by reference.

### TECHNICAL FIELD

The present disclosure relates to a retinal projection device.

### BACKGROUND

Near-eye wearable devices such as smart glasses are known. For example, US 2018/0113310 A1 discloses a near eye display assembly including an image source and a combiner including a nanostructured surface optically coupled to the image source, wherein the image information is formed on the nanostructured surface of the combiner to be conveyed within a field of view of a user.

### SUMMARY

In the near-eye display assembly described in US 2018/0113310 A1, the nanostructured surface functions as a reflecting surface. In a reflector such as a mirror formed of such a nanostructure (meta-optics mirror) and a diffractive mirror, the reflection angle of light may change depending on the wavelength of light. Therefore, when an image is projected onto the retina of the user, chromatic aberration may occur.

The present disclosure describes a retinal projection device capable of reducing chromatic aberration.

A retinal projection device according to one aspect of the present disclosure is a device to be mounted on a near-eye wearable device. The retinal projection device includes: a light source that emits laser light; a movable mirror that performs scanning with the laser light; and a reflector that projects an image onto a retina of a user wearing the near-eye wearable device by reflecting the laser light having passed through the movable mirror and irradiating the retina with reflected light. The reflector includes: a reflective layer that reflects the laser light at a reflection angle that changes depending on a wavelength of the laser light and emits the laser light as the reflected light; and a phase correction layer that corrects chromatic aberration of the reflected light.

In the retinal projection device, the laser light is reflected as reflected light by the reflective layer at a reflection angle that changes depending on the wavelength of the laser light, and the chromatic aberration of the reflected light is corrected by the phase correction layer. Therefore, chromatic aberration can be reduced.

In some embodiments, the phase correction layer may be a metalens including a plurality of columnar bodies having visible light transparency. In this case, when visible light passes through each columnar body, a phase delay of the visible light occurs in accordance with the size of the columnar body. Therefore, by appropriately adjusting the phase delay amount occurring in each columnar body, chromatic aberration can be reduced.

In some embodiments, the phase correction layer may be made of one compound selected from a group consisting of silicon oxides, titanium oxides, tantalum oxides, and silicon nitrides. Since these compounds are transparent in the visible light region, the visible light transparency of the phase correction layer can be realized.

In some embodiments, a size of each of the plurality of columnar bodies may be set such that, at a position where a respective columnar body is provided, a phase of red light and a phase of blue light are in phase. The maximum wavelength of the operating wavelength band in the retinal projection device is the wavelength of the red light, and the minimum wavelength of the operating wavelength band is the wavelength of the blue light. For this reason, by making the phase of the red light and the phase of the blue light in phase, the maximum phase delay amount occurring in the operating wavelength band can be eliminated. This makes it possible to reduce chromatic aberration.

In some embodiments, the reflective layer may be a metamirror including a plurality of nanostructures provided along a surface of a lens of the near-eye wearable device, the surface facing an eyeball of the user. Each of the plurality of nanostructures may include a metal layer, a dielectric layer, and a metal body sequentially stacked in a direction intersecting the above-described surface. In this case, the reflective layer can function as a reflective mirror due to electromagnetic resonance between the metal layer and the metal body.

In some embodiments, the reflective layer may be a metamirror including a plurality of nanostructures provided along a surface of a lens of the near-eye wearable device, the surface facing an eyeball of the user. Each of the plurality of nanostructures may include a first transparent conductive layer, a dielectric layer, and a second transparent conductive layer sequentially stacked in a direction intersecting the above-described surface. In this case, the reflective layer can function as a reflective mirror due to electromagnetic resonance between the first transparent conductive layer and the second transparent conductive layer. Furthermore, by using the transparent conductive layers, it is possible to reduce a possibility that a field of view is obstructed.

In some embodiments, the first transparent conductive layer and the second transparent conductive layer may be made of ITO. Since ITO has excellent electrical conductivity and high transparency in the visible light region, it is suitable for the transparent conductive layer.

In some embodiments, the reflective layer may be configured such that a predetermined reflection angle is obtained for a reference wavelength. Since the reflection angle at the reflective layer changes depending on the wavelength, the length of the metal body along the above-described surface can be set by using the reference wavelength.

In some embodiments, the reference wavelength may be a wavelength of red light contained in the laser light. In this case, since the length of the metal body along the surface can be increased, the manufacturing of the reflector can be facilitated.

In some embodiments, the reflector may further include a dielectric spacer layer provided between the reflective layer and the phase correction layer. In this case, by providing the dielectric spacer layer, a surface planarization process such as CMP can be performed to planarize the surface of the dielectric spacer layer.

In some embodiments, the dielectric spacer layer may be made of one compound selected from a group consisting of silicon oxides, titanium oxides, tantalum oxides, and silicon nitrides. In this case, since a material having a refractive index that is the same as or close to the refractive index of the phase correction layer can be used, unnecessary interface reflection can be suppressed.

According to each aspect and each embodiment of the present disclosure, chromatic aberration can be reduced.

### BRIEF DESCRIPTION OF THE DRAWINGS

FIG. 1 is a perspective view showing an appearance of a near-eye wearable device including a retinal projection device according to an embodiment.

FIG. 2 is a configuration diagram schematically showing the retinal projection device shown in FIG. 1.

FIG. 3 is an enlarged view of the reflector shown in FIG. 2.

FIG. 4 is a cross-sectional view taken along the line IV-IV of FIG. 3.

FIG. 5 is a perspective view showing a reflective layer included in the unit region shown in FIG. 3.

FIG. 6 is a diagram schematically showing the reflector shown in FIG. 2.

FIG. 7A is a diagram for explaining reflected light at a position (−r).

FIG. 7B is a diagram for explaining reflected light at a position (+r).

FIG. 8 is a diagram showing the relationship between the position of the reflector in the X-axis direction and the maximum phase delay amount.

FIG. 9 is a diagram showing the relationship between the diameter of the columnar body and the phase delay amount.

FIG. 10 is a diagram showing the diameter of the columnar body at each position in the X-axis direction of the reflector.

FIG. 11 is a diagram for explaining the formation of the reflective layer.

FIG. 12 is a diagram for explaining the formation of the dielectric layer.

FIG. 13 is a diagram for explaining the planarization of the dielectric layer.

FIG. 14 is a diagram for explaining the formation of the light-transmitting layer.

### DETAILED DESCRIPTION

Hereinafter, embodiments of the present disclosure will be described in detail with reference to the drawings. In the description of the drawings, the same elements are denoted by the same reference numerals, and redundant description will be omitted. In each figure, an XYZ coordinate system may be shown. The Y-axis direction is a direction intersecting (for example, orthogonal to) the X-axis direction and the Z-axis direction. The Z-axis direction is a direction intersecting (for example, orthogonal to) the X-axis direction and the Y-axis direction.

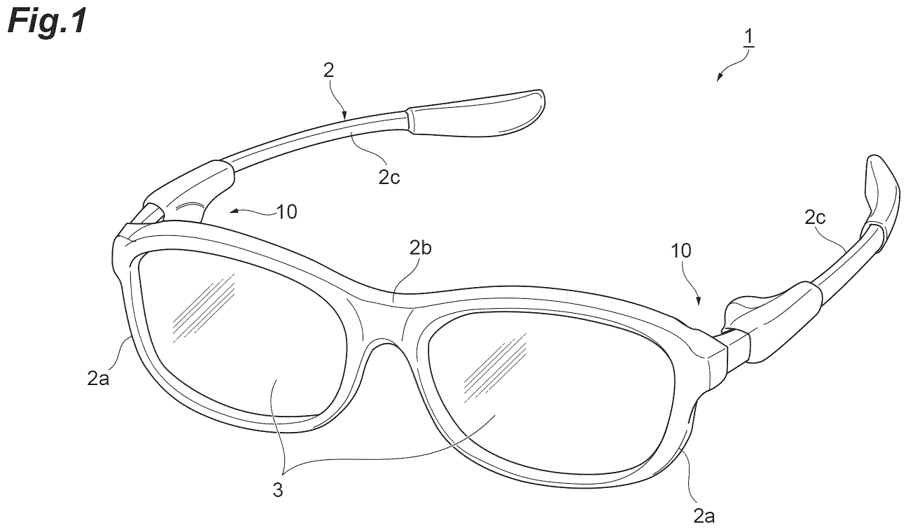

A near-eye wearable device including a retinal projection device according to an embodiment will be described with reference to FIG. 1. FIG. 1 is a perspective view showing an appearance of a near-eye wearable device including a retinal projection device according to an embodiment. The near-eye wearable device 1 shown in FIG. 1 is a device for superimposing an image on the field of view of the real world. The near-eye wearable device 1 is, for example, a head-mounted device, and may take the form of an eyeglass type, a goggle type, a hat type, a helmet type, or the like. Examples of the near-eye wearable device 1 include smart glasses such as augmented reality (AR) glasses, and mixed reality (MR) glasses. The near-eye wearable device 1 includes a frame 2, a lens 3, and a retinal projection device 10.

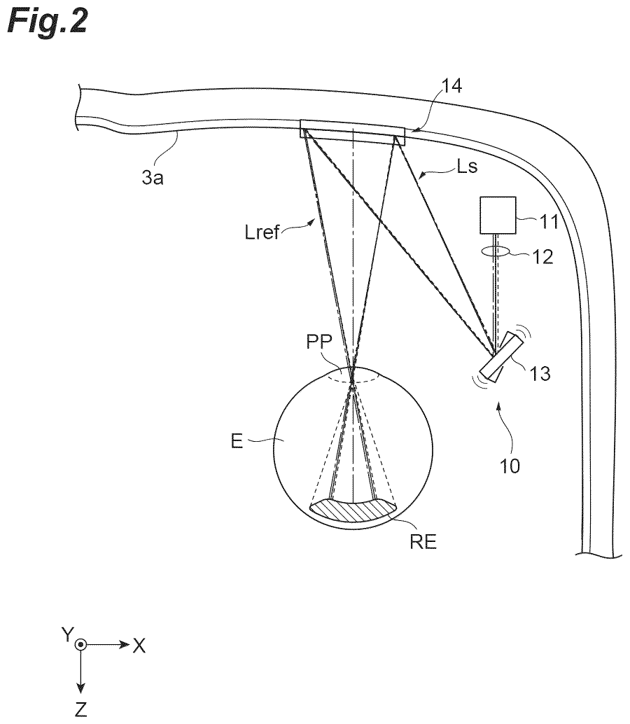

The frame 2 includes a pair of rims 2a, a bridge 2b, and a pair of temples 2c. The rim 2a is a part for holding the lens 3. The bridge 2b is a part connecting the pair of rims 2a. The temple 2c extends from the rim 2a and is a part to be put on an ear of a user. The frame 2 may be a rimless frame. The lens 3 has an inner surface 3a (refer to FIG. 2) facing an eyeball E (refer to FIG. 2) of a user wearing the near-eye wearable device 1.

In the present embodiment, the retinal projection device 10 directly projects (draws) an image onto a retina RE (refer to FIG. 2) of a user wearing the near-eye wearable device 1. The retinal projection device 10 is mounted on the near-eye wearable device 1. In the present embodiment, the near-eye wearable device 1 includes two retinal projection devices 10 in order to project an image onto both the right and left retinas RE, but may include only one of the retinal projection devices 10.

Next, the retinal projection device 10 will be described in detail with reference to FIG. 2. FIG. 2 is a configuration diagram schematically showing the retinal projection device shown in FIG. 1. As shown in FIG. 2, the retinal projection device 10 includes a light source unit 11 (light source), a collimator lens 12, a movable mirror 13, and a reflector 14.

The light source unit 11 emits laser light. As the light source unit 11, for example, a full-color laser module is used. The light source unit 11 includes a red laser diode, a green laser diode, a blue laser diode, and a multiplexer that multiplexes laser lights emitted from the laser diodes. The light source unit 11 emits the multiplexed laser light. The multiplexed laser light includes at least one component of light having a red wavelength λ_{red} (red light Lr), light having a green wavelength λ_{green} (green light Lg), and light having a blue wavelength λ_{blue} (blue light Lb). In the following description, the red light Lr, the green light Lg, and the blue light Lb may be rephrased as “visible light”, and the red light Lr, the green light Lg, and the blue light Lb may be collectively referred to as “laser light Ls”. The light source unit 11 emits laser light having a color and intensity corresponding to the pixel of the image to be projected onto the retina RE.

The collimator lens 12 is an optical component for converting the laser light emitted from the light source unit 11 into parallel light. The collimator lens 12 is provided between the light source unit 11 and the movable mirror 13.

The movable mirror 13 is an optical component for performing scanning with the laser light Ls. The movable mirror 13 is provided in a direction in which the laser light converted into the parallel light by the collimator lens 12 is emitted. The movable mirror 13 is configured to be swingable about an axis extending in the horizontal direction (X-axis direction) of the lens 3 and about an axis extending in the vertical direction (Y-axis direction) of the lens 3, for example, and reflects the laser light while changing the angle in the X-axis direction and the Y-axis direction. As the movable mirror 13, for example, a micro electro mechanical systems (MEMS) mirror is used.

The reflector 14 is an optical component that projects an image onto the retina RE of the user wearing the near-eye wearable device 1 by reflecting the laser light Ls having passed through the movable mirror 13 and irradiating the retina RE with reflected light Lref. No image is displayed on the reflector 14. The reflector 14 is provided on the inner surface 3a of the lens 3. Details of the reflector 14 will be described later.

Although not shown, the retinal projection device 10 further includes a laser driver for driving the light source unit 11, a mirror driver for driving the movable mirror 13, and a controller for controlling the laser driver and the mirror driver.

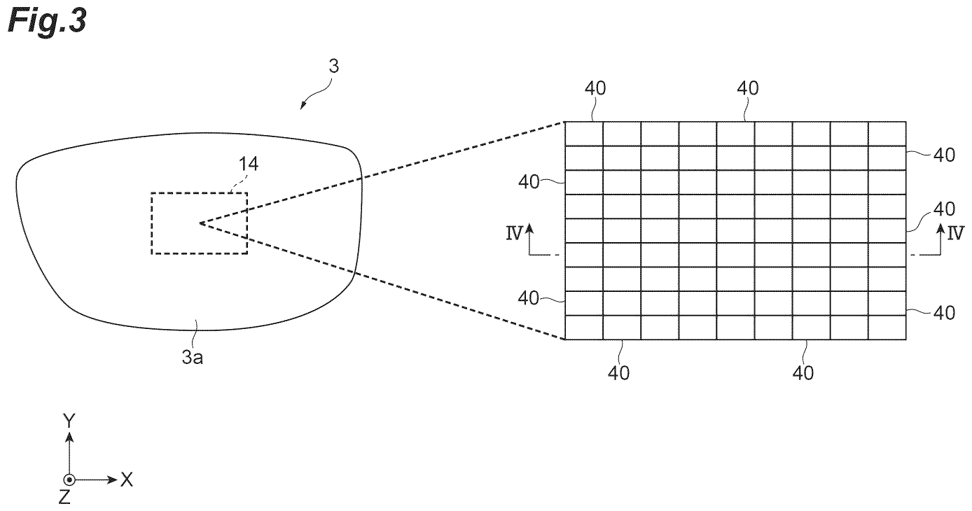

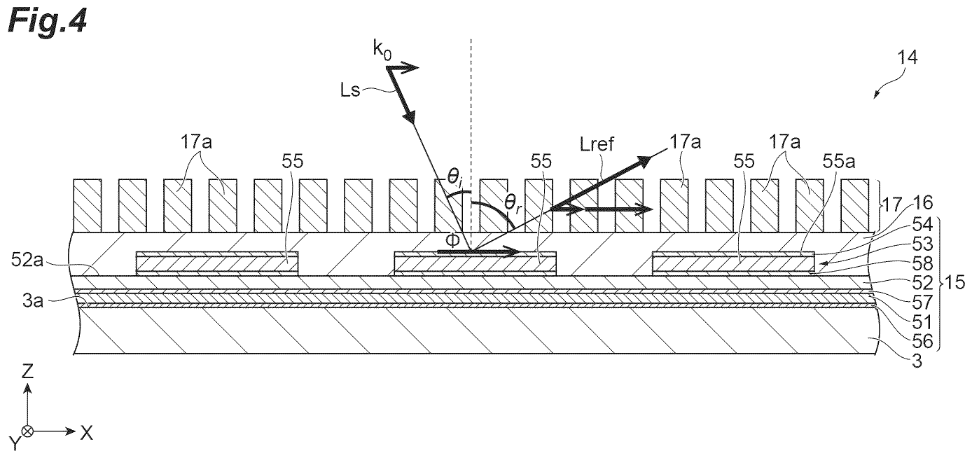

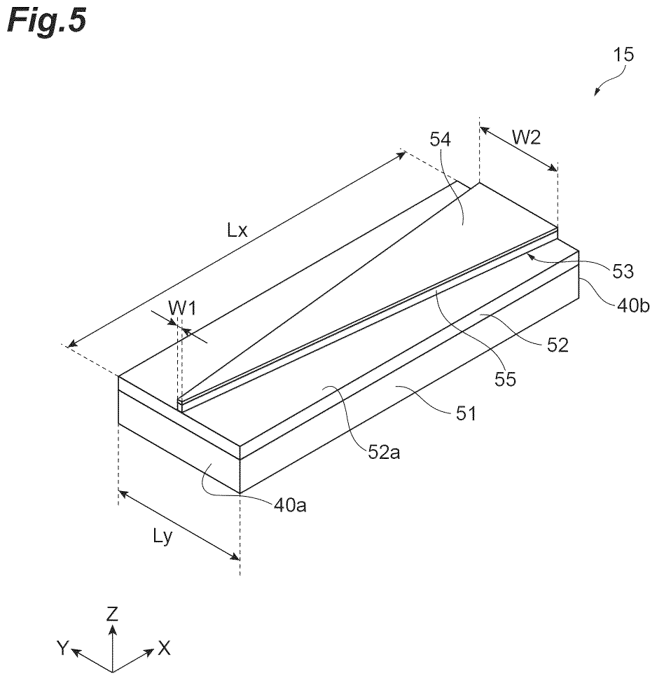

Next, the configuration of the reflector 14 will be described with reference to FIGS. 3 to 5. FIG. 3 is an enlarged view of the reflector shown in FIG. 2. FIG. 4 is a cross-sectional view taken along the line IV-IV of FIG. 3. FIG. 5 is a perspective view showing a reflective layer included in the unit region shown in FIG. 3.

As shown in FIG. 3, the reflector 14 is divided into a plurality of unit regions 40. The plurality of unit regions 40 are provided along the inner surface 3a of the lens 3. The plurality of unit regions 40 are arranged in a two-dimensional array in the horizontal direction (X-axis direction) and the vertical direction (Y-axis direction) of the lens 3.

As shown in FIG. 4, each unit region 40 is configured to reflect the laser light Ls at a reflection angle θr corresponding to a position where the unit region 40 is provided when the laser light Ls is incident on the unit region 40 at an incident angle θᵢ corresponding to the position where the unit region 40 is provided. The reflection angle θᵣ of each unit region 40 is set so that the laser light Ls (reflected light Lref) reflected by each unit region 40 passes through the center of the pupil PP (refer to FIG. 2). Therefore, the incident angle θj and the reflection angle θᵣ are determined by the position where the unit region 40 is provided. The unit region 40 is configured to obtain the incident angle θᵢ and the reflection angle θᵣ corresponding to the position where the unit region 40 is provided.

Here, the incident angle θᵢ is an angle formed by a normal line of a surface irradiated with the laser light Ls and an incident direction of the laser light Ls. The reflection angle θᵣ is an angle formed by a normal line of a surface irradiated with the laser light Ls and an emission direction of the reflected light Lref. In the plane including the laser light Ls and the reflected light Lref, when the reflected light Lref is emitted on the side opposite to the incident light (laser light Ls) with the normal line as a boundary, the reflection angle θᵣ is expressed by a positive value, and when the reflected light Lref is emitted on the same side as the incident light (laser light Ls) with the normal line as a boundary, the reflection angle θᵣ is expressed by a negative value.

As shown in FIGS. 4 and 5, the reflector 14 includes a reflective layer 15, a dielectric spacer layer 16, and a phase correction layer 17, which are sequentially stacked in a direction (Z-axis direction) intersecting (e.g., orthogonal to) the inner surface 3a.

The reflective layer 15 is a metamirror including a plurality of nanostructures provided along the inner surface 3a. The metamirror is also referred to as a meta-optics mirror. The reflective layer 15 reflects the laser light Ls at a reflection angle θᵣ that changes depending on the wavelength of the laser light Ls and emits the laser light as reflected light Lref. The reflective layer 15 is configured to reflect the laser light Ls at a reflection angle θᵣ corresponding to the position where the laser light Ls is incident. The reflective layer 15 includes a metal layer 51, a dielectric layer 52, a metal layer 53, and a protective layer 54, which are sequentially stacked in a direction (Z-axis direction) intersecting (e.g., orthogonal to) the inner surface 3a.

The metal layer 51 is a base layer. The metal layer 51 is provided on the inner surface 3a of the lens 3. The metal layer 51 is made of a metal having high reflection characteristics in the visible light region. The metal layer 51 is made of, for example, a metal containing at least one element selected from the group consisting of gold (Au), copper (Cu), silver (Ag), and aluminum (Al). The length of the metal layer 51 in the Z-axis direction may be any length as long as the metal layer 51 is capable of passing a resonance current and reflecting light, and is, for example, 10 nm to 1000 nm. Hereinafter, the length in the Z-axis direction may be referred to as “thickness”.

The dielectric layer 52 is a layer functioning as a spacer. The dielectric layer 52 is provided between the metal layer 51 and the metal layer 53 in the Z-axis direction. The dielectric layer 52 has a main surface 52a on which the metal layer 53 is provided. The dielectric layer 52 has a dielectric constant that does not interfere with the electromagnetic action of the metal layer 51 and the metal layer 53. The dielectric layer 52 is made of a material that is transparent in the visible light region. The dielectric layer 52 may be made of a material having a high dielectric constant in order to achieve high reflection characteristics. The dielectric layer 52 is made of, for example, one compound selected from the group consisting of silicon oxides (e.g., SiO₂), titanium oxides (e.g., TiO₂), magnesium oxides (e.g., MgO), and aluminum oxides (e.g., Al₂O₃). The thickness of the dielectric layer 52 is, for example, 10 nm to 100 nm.

The metal layer 53 is a layer for exciting electromagnetic resonance together with the metal layer 51. The metal layer 51 and the metal layer 53 are stacked in the Z-axis direction with the dielectric layer 52 interposed therebetween. In the present embodiment, the metal layer 53 is provided on the main surface 52a of the dielectric layer 52. The metal layer 53 is made of a metal having high reflection characteristics in the visible light region. The metal layer 53 is made of, for example, a metal containing at least one element selected from the group consisting of silver (Ag), aluminum (Al), and copper (Cu).

The metal layer 53 includes a plurality of metal bodies 55. A metal body 55 is provided in each of the plurality of unit regions 40. Each metal body 55 is configured such that a phase change amount φ of the reflected light Lref by the metal body 55 changes linearly from one end 40a to the other end 40b in the X-axis direction of the unit region 40 in which the metal body 55 is provided. Furthermore, each metal body 55 is configured such that the phase change amount φ of the reflected light Lref changes by substantially 360° (2π radians) from the one end 40a to the other end 40b. The phase change amount φ of the reflected light Lref is an amount of change in the phase of the reflected light Lref that occurs when the length of the metal body 55 in the Y-axis direction is changed, wherein the phase of the reflected light Lref at a certain length of the metal body 55 in the Y-axis direction is used as a reference. Hereinafter, the length in the Y-axis direction may be referred to as “width”.

In the present embodiment, each metal body 55 is a single metal body having a trapezoidal shape when viewed from the Z-axis direction. The thickness of each metal body 55 is, for example, 10 nm to 100 nm. The length of each metal body 55 in the X-axis direction is equal to or slightly shorter than the length Lx of the unit region 40 in the X-axis direction. The length of each metal body 55 in the X-axis direction is, for example, 500 nm to 2500 nm.

The length of the short side (width W1) of each metal body 55 is set, for example, to a value close to the resolution of the exposure device used for forming the metal body 55. The width W1 is, for example, 10 nm to 200 nm. The length of the long side (width W2) of each metal body 55 is larger than the width W1, and is set to a length at which a phase difference of substantially 360° (2π radians) is obtained from the phase of the reflected light Lref at the width W1. The width W2 is, for example, 100 nm to 500 nm. Each metal body 55 is formed by, for example, photolithography.

The protective layer 54 is a layer for protecting the metal layer 53 (metal body 55). The protective layer 54 is provided on a surface 55a of each metal body 55 and covers the surface 55a. The surface 55a is a surface of the metal layer 53 opposite to the dielectric layer 52. The protective layer 54 is made of a metal which is less susceptible to oxidation and sulfurization and has higher corrosion resistance than the metal layer 53. In other words, the protective layer 54 is made of a metal having a standard electrode potential higher than that of the metal constituting the metal layer 53. The protective layer 54 is made of, for example, a metal containing at least one element selected from the group consisting of gold (Au), ruthenium (Ru), and iridium (Ir). In a combination of these metals and the metal constituting the metal layer 53 (e.g., silver), the attenuation of the near-field light is small.

In the present embodiment, the protective layer 54 includes a plurality of metal bodies having the same shape as the metal bodies 55 when viewed from the Z-axis direction. The thickness of the protective layer 54 (metal body) is 20% or less of the total of the thickness of the metal body 55 and the thickness of the protective layer 54, and is, for example, 2.5 nm to 25 nm.

The dielectric spacer layer 16 is a layer for absorbing a difference in refractive index between the reflective layer 15 and the phase correction layer 17 while ensuring planarity before forming the phase correction layer 17. The dielectric spacer layer 16 is provided between the reflective layer 15 and the phase correction layer 17. The dielectric spacer layer 16 is made of a material that is transparent in the visible light region. The dielectric spacer layer 16 is made of one compound selected from the group consisting of silicon oxides (SiO₂), titanium oxides (TiO), tantalum oxides (Ta₂O₅), and silicon nitrides (SiN). The thickness of the dielectric spacer layer 16 is, for example, 50 nm or less. From the viewpoint of reducing the influence on the reflection efficiency of the reflector 14, the thickness of the dielectric spacer layer 16 may be 10 nm or less.

The phase correction layer 17 is a layer for correcting chromatic aberration of the reflected light Lref. The phase correction layer 17 is provided on the dielectric spacer layer 16. The phase correction layer 17 is made of a material that is transparent in the visible light region.

The phase correction layer 17 is a metalens including a plurality of columnar bodies 17a. Each columnar body 17a is a columnar member having visible light transparency. That is, each columnar body 17a is a columnar member that is transparent in the visible light region. As a constituent material of the columnar body 17a, a material having visible light transparency and a refractive index higher than 1 is used. Examples of such a constituent material include silicon oxides (SiO₂), titanium oxides (TiO), tantalum oxides (Ta₂O₅), and silicon nitrides (SiN). In other words, the phase correction layer 17 is made of one compound selected from the group consisting of silicon oxides (SiO₂), titanium oxides (TiO), tantalum oxides (Ta₂O₅), and silicon nitrides (SiN).

In the present embodiment, each columnar body 17a has a cylindrical shape. The shape of each columnar body 17a is not limited to a cylinder, and may be a rectangular column, or may be a truncated cone or a truncated pyramid with a tapered tip. Each columnar body 17a is erected on the dielectric spacer layer 16. That is, each columnar body 17a extends from the dielectric spacer layer 16 in the emission direction of the reflected light Lref. The height (length in the Z-axis direction) of each columnar body 17a is, for example, 500 nm or more and 2000 nm or less.

The size of each columnar body 17a is set such that a phase of red light Lr and a phase of blue light Lb are in phase at a position where the columnar body 17a is provided. A method for determining the size of the columnar body 17a will be described later.

As shown in FIG. 4, an adhesion layer 56 may be provided between the inner surface 3a of the lens 3 and the metal layer 51. An adhesion layer 57 may be provided between the metal layer 51 and the dielectric layer 52. An adhesion layer 58 may be provided between the dielectric layer 52 and the metal layer 53. Each of the adhesion layers 56 to 58 is a layer for enhancing the adhesion between two layers. Each of the adhesion layers 56 to 58 is made of, for example, chromium (Cr). The length (film thickness) of each of the adhesion layers 56 to 58 in the Z-axis direction is about 3 nm. In FIG. 5, the adhesion layers 56 to 58 are not shown.

Next, the reflection principle in the reflective layer 15 will be described with reference to FIGS. 4 and 5.

As described above, the width of the metal body 55 increases from the width W1 at the one end 40a to the width W2 at the other end 40b. The phase change amount φ at each position of the metal body 55 in the X-axis direction is substantially the same as the phase change amount φ caused by the square metal body having sides having the same length as the width at the position in the plan view. The larger the area of the square metal body in the plan view, the larger the phase change amount φ (phase delay amount) at that position. Accordingly, since the laser light Ls is reflected with different phase change amounts φ in accordance with the position in the X-axis direction, the wave front is formed by the interference between the reflected lights. That is, a plane wave having the gradient of the function φ(x) indicating the relationship between the position x in the X-axis direction and the phase change amount φ as the wave vector Φ is generated.

Here, as shown in FIG. 4, by generalizing the Snell's law, the Snell's law is expressed by Equation (1) using the wave vector k₀ of the laser light Ls, the incident angle θj, the reflection angle θᵣ, and the wave vector Φ.

$$\begin{matrix}[ Equation 1 ] & \\ {k}_{0} \times sin {θ}_{i} + Φ = {k}_{0} \times sin {θ}_{r} & ( 1 )\end{matrix}$$

The wave vector k₀ is expressed by 2λ/λ using the wavelength λ of the laser light Ls. The wavelength λ represents an arbitrary wavelength included in the operating wavelength band. The operating wavelength band is a range (band) of wavelengths used in the retinal projection device 10. The wave vector Φ is expressed by 2π/Lx using the length Lx of the unit region 40 in the X-axis direction. By transforming Equation (1) using these relations, Equation (2) is obtained.

$$\begin{matrix}[ Equation 2 ] & \\ sin {θ}_{r} = sin {θ}_{i} + \frac{λ}{L x} & ( 2 )\end{matrix}$$

The length Lx of the unit region 40 is obtained by substituting the wavelength λ of the laser light Ls and the incident angle θᵢ and the reflection angle θᵣ of the laser light Ls corresponding to the position where the unit region 40 is provided into Equation (2). Here, the length Lx is determined using a reference wavelength λ_{ref} as the wavelength λ. That is, the reflective layer 15 is configured such that a predetermined reflection angle θᵣ is obtained for the reference wavelength λ_{ref}. Here, the wavelength λ_{red} of the red component (red light Lr) contained in the laser light Ls is used as the reference wavelength λ_{ref}. The wavelength λ_{blue} of the blue component (blue light Lb) contained in the laser light Ls may be used as the reference wavelength λ_{ref}.

When the length Lx is a positive value, the shape of the metal body 55 is set to a trapezoidal shape in which the width of the metal body 55 increases from the one end 40a to the other end 40b. When the length Lx is a negative value, the shape of the metal body 55 is set to a trapezoidal shape in which the width of the metal body 55 decreases from the one end 40a to the other end 40b.

As described above, the length Lx of each unit region 40 is determined by the reference wavelength λ_{ref} and the incident angle θᵢ and the reflection angle θᵣ corresponding to the position where the unit region 40 is provided. The length of the metal body 55 in the X-axis direction is the same as or slightly shorter than the length Lx of the unit region 40 in the X-axis direction. Accordingly, the length of the metal body 55 in the X-axis direction is determined by the reference wavelength λ_{ref} and the incident angle θᵢ and the reflection angle θᵣ corresponding to the position of the unit region 40 where the metal body 55 is provided. As shown in Equation (2), the reflection angle θᵣ changes depending on the wavelength of the light component contained in the laser light Ls.

The length Ly of each unit region 40 in the Y-axis direction is a predetermined fixed value. The length Ly is slightly larger than the width W2. The length Ly may be a length obtained by adding the resolution (e.g., 100 nm) of the exposure device used for forming the metal body 55 to the width W2, and is set to, for example, 600 nm. The width W1 and the width W2 of each metal body 55 are predetermined fixed values. As described above, the width W1 is set to a value close to the resolution (e.g., 100 nm) of the exposure device used for forming the metal body 55. The width W2 is set to a length (e.g., 350 nm) at which a phase difference of substantially 360° (2π radians) is obtained from the phase of the reflected light Lref at the width W1.

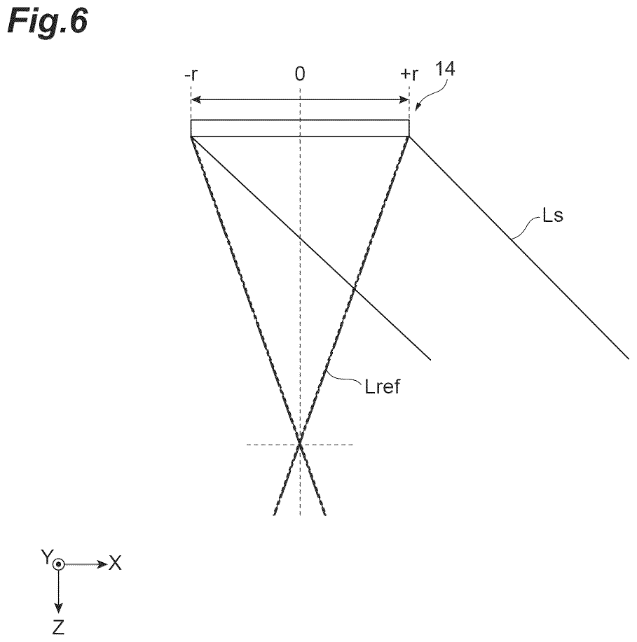

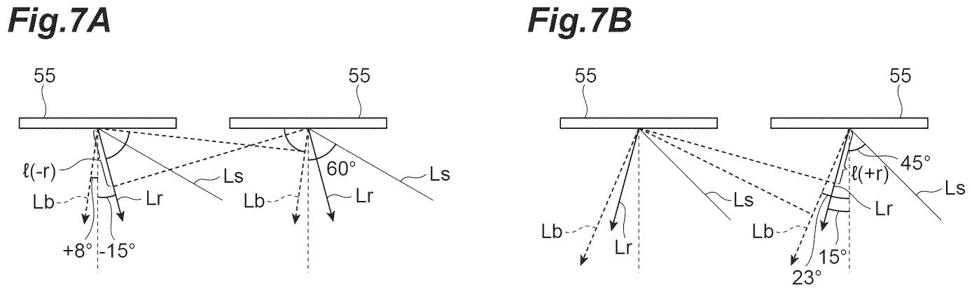

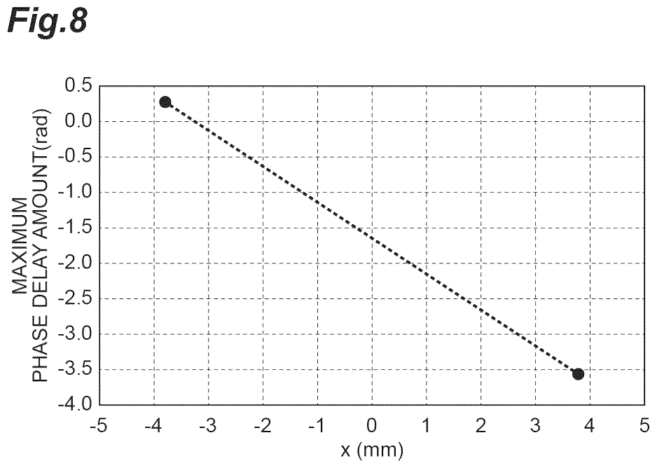

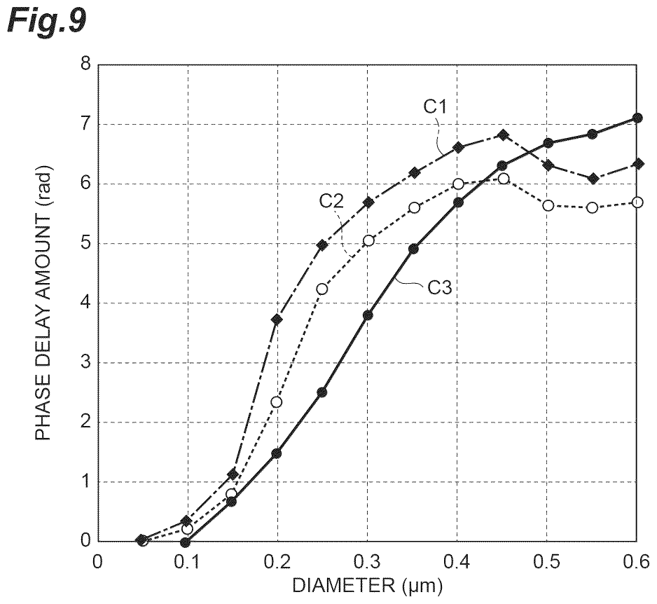

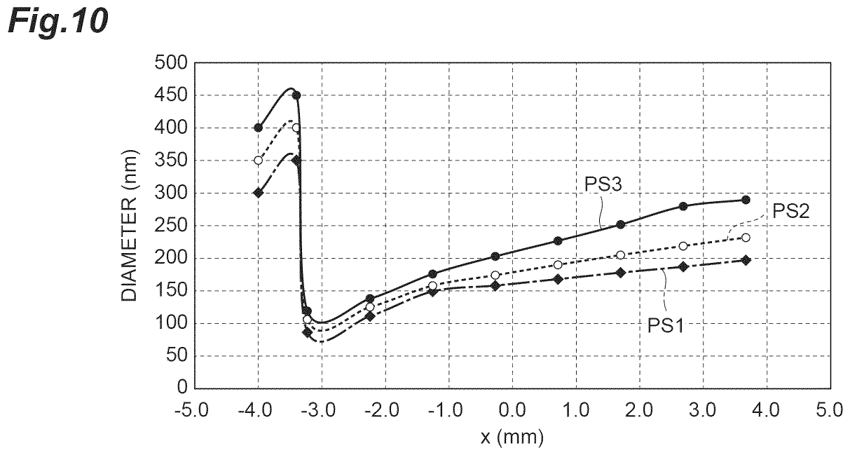

Next, a method for determining the size of the columnar body 17a will be described with reference to FIGS. 6 to 10. FIG. 6 is a diagram schematically showing the reflector shown in FIG. 2. FIG. 7A is a diagram for explaining reflected light at a position (−r). FIG. 7B is a diagram for explaining reflected light at a position (+r). FIG. 8 is a diagram showing the relationship between the position of the reflector in the X-axis direction and the maximum phase delay amount. FIG. 9 is a diagram showing the relationship between the diameter of the columnar body and the phase delay amount. FIG. 10 is a diagram showing the diameter of the columnar body at each position in the X-axis direction of the reflector.

As shown in FIG. 6, the position x at the center of the reflector 14 in the X-axis direction is set to 0, the position x at the end closer to the movable mirror 13 among both ends of the reflector 14 in the X-axis direction is set to +r, and the position x at the end farther from the movable mirror 13 is set to −r.

Here, the phase amount φₘ(x) of the reflected light Lref at the position x after wave front adjustment is approximated by Equation (3) using the wavelength λ and the optical path length difference l(x). The optical path length difference l(x) is an optical path length difference between two metal bodies 55 which are adjacent to each other in the X-axis direction. That is, Equation (3) means that the phases of the laser light reflected by the two metal bodies 55 are matched by returning a phase amount corresponding to the optical path length difference between the two adjacent metal bodies 55.

$$\begin{matrix}[ Equation 3 ] & \\ {φ}_{m} ( x ) = - \frac{2 π}{λ} l ( x ) + const & ( 3 )\end{matrix}$$

By transforming Equation (3) using the maximum wavelength λₘₐₓ in the operating wavelength band, Equation (4) is obtained.

$$\begin{matrix}[ Equation 4 ] & \\ {φ}_{m} ( x ) = - \frac{2 π}{{λ}_{max}} l ( x ) - 2 π l ( x ) ( \frac{1}{λ} - \frac{1}{{λ}_{max}} ) + const & ( 4 )\end{matrix}$$

Here, the wavelength λ is expressed by Equation (5) using the angular frequency ω and the light speed c.

$$\begin{matrix}[ Equation 5 ] & \\ \frac{1}{λ} = \frac{ω}{2 π c} & ( 5 )\end{matrix}$$

By transforming Equation (4) using Equation (5), Equation (6) is obtained.

$$\begin{matrix}[ Equation 6 ] & \\ {φ}_{m} ( x ) = - \frac{2 π}{{λ}_{max}} l ( x ) - \frac{l ( x )}{c} ( ω - {ω}_{min} ) + const & ( 6 )\end{matrix}$$

The optical path length difference l(x) is expressed by Equation (7), and the angular frequency ω is expressed by Equation (8) using the wavenumber k and the speed of light c.

$$\begin{matrix}[ Equation 7 ] & \\ l ( x ) = - c \frac{{δφ}_{m}}{δω} & ( 7 )\end{matrix}$$

$$\begin{matrix}[ Equation 8 ] & \\ kc = ω & ( 8 )\end{matrix}$$

By transforming Equation (6) using Equations (7) and (8), Equation (9) is obtained.

$$\begin{matrix}[ Equation 9 ] & \\ {φ}_{m} ( x ) = - {k}_{min} l ( x ) + \frac{δφ}{δ k} ( k - {k}_{min} ) + const & ( 9 )\end{matrix}$$

By transforming Equation (9) using the maximum wavenumber kₘₐₓ and the minimum wavenumber kₘᵢₙ, Equation (10) is obtained.

$$\begin{matrix}[ Equation 10 ] & \\ {φ}_{m} ( x ) = - {k}_{min} l ( x ) + \frac{φ ( {k}_{min} , x ) - φ ( {k}_{max} , x )}{{k}_{max} - {k}_{min}} ( k - {k}_{min} ) + c o n s t & ( 10 )\end{matrix}$$

Since the first term on the right side of Equation (10) is the optical path length difference determined by the reflection angle θᵣ, the first term on the right side is determined by the geometric design of the reflective layer 15. Therefore, the first term on the right is a fixed value at a certain position x. The second term on the right side of Equation (10) changes depending on the wavenumber (wavelength), and thus corresponds to the phase correction amount caused by the phase correction layer 17. The size of the columnar body 17a is determined to be a size corresponding to the phase correction amount, with the case where the wavenumber k is the maximum wavenumber kₘₐₓ as a reference. Hereinafter, specific examples will be used for explanation. The maximum wavelength λₘₐₓ of the operating wavelength band is the wavelength λ_{red} of the red light Lr, and the minimum wavelength λₘᵢₙ of the operating wavelength band is the wavelength λ_{blue} of the blue light Lb.

In the example shown in FIG. 7A, as shown in Equation (11), at the position (−r), the angle difference obtained by subtracting the reflection angle θ_{r_blue} of the blue light from the reflection angle θ_{r_red} of the red light is −23°. Note that 630 nm is used as the maximum wavelength λₘₐₓ (wavelength λ_{red}), and 450 nm is used as the minimum wavelength λₘᵢₙ (wavelength λ_{blue}). 450 nm is used as the length Lx at the position (−r).

$$\begin{matrix}[ Equation 11 ] & \\ {θ}_{r \_ red} - {θ}_{r \_ blue} ≅ ( {λ}_{max} - {λ}_{min} ) = - 23 ° & ( 11 )\end{matrix}$$

At the position (−r), the reflective layer 15 is designed such that the incident angle θᵢ of the laser light Ls is 60° and the reflection angle θ_{r_red} is −15°. At this time, the reflection angle θ_{r_blue} is +8° from Equation (11). The optical path length difference l(−r) of the red light is 116 nm (=Lx×cos(90°−|θ_{r_red}|)), and the optical path length difference l(−r) of the blue light is 70 nm (=Lx×cos(90°−|θ_{r_blue}|)). Therefore, the phase change amount φ(kₘᵢₙ, −r) corresponding to the optical path length difference l(−r) of the red light is 1.16 radians (=2π×optical path length difference l(−r)/λₘₐₓ), and the phase change amount P (kₘₐₓ, −r) corresponding to the optical path length difference l(−r) of the blue light is 0.87 radians (=2π×optical path length difference l(−r)/λₘᵢₙ). Thus, the maximum phase difference (maximum phase delay amount) in the operating wavelength band at the position (−r) is 0.29 radians.

In the example shown in FIG. 7B, as shown in Equation (12), at the position (+r), the angle difference obtained by subtracting the reflection angle θ_{r_blue} of the blue light from the reflection angle θ_{r_red} of the red light is −9°. 1150 nm is used as the length Lx at the position (+r).

$$\begin{matrix}[ Equation 12 ] & \\ {θ}_{r \_ red} - {θ}_{r \_ blue} ≅ \frac{- 1}{Lx} ( {λ}_{max} - {λ}_{min} ) = - 9 ° & ( 12 )\end{matrix}$$

At the position (+r), the reflective layer 15 is designed such that the incident angle θᵢ of the laser light Ls is 45° and the reflection angle θ_{r_red} is +15°. At this time, the reflection angle θ_{r_blue} is +24° from Equation (12). The optical path length difference l(+r) of the red light is 298 nm, and the optical path length difference l(+r) of the blue light is 468 nm. Therefore, the phase change amount φ(kₘᵢₙ, +r) corresponding to the optical path length difference l(+r) of the red light is 2.97 radians, and the phase change amount φ (kₘₐₓ, +r) corresponding to the optical path length difference l(+r) of the blue light is 6.53 radians. The maximum phase difference (maximum phase delay amount) in the operating wavelength band at the position (+r) is −3.56 radians.

Assuming that the maximum phase difference (maximum phase delay amount) in the operating wavelength band is expressed as a linear function of the position x from the position (+r) to the position (−r), the relationship between the position x and the maximum phase delay amount as shown in FIG. 8 is obtained. The horizontal axis in FIG. 8 indicates the position x (unit: mm), and the vertical axis in FIG. 8 indicates the maximum phase delay amount (unit: radian). In this example, the position (+r) is 3.8 mm, and the position (−r) is −3.8 mm.

At each position x, the size of the columnar body 17a is determined so that the maximum phase delay amount shown in FIG. 8 is obtained. In the present embodiment, in order to facilitate the manufacturing of the reflector 14, all the columnar bodies 17a included in the phase correction layer 17 have a cylindrical shape, are made of the same constituent material, and are set to the same height. In this case, the diameter of the columnar body 17a is a parameter that determines the phase delay amount.

As shown in FIG. 9, the phase delay amount caused by each columnar body 17a changes depending on the diameter of the columnar body 17a when the constituent material and height of the columnar bodies 17a are the same. The horizontal axis in FIG. 9 indicates the diameter of the columnar body 17a (unit: μm), and the vertical axis in FIG. 9 indicates the phase delay amount (unit: radian). The characteristics shown in FIG. 9 are characteristics calculated in advance by numerical calculation. Characteristic C1 is a characteristic of a cylindrical columnar body made of tantalum pentoxide (Ta₂O₅) having a height of 500 nm, with aluminum oxide (Al₂O₃) having a height of 200 Å provided at both ends thereof. Characteristic C2 is a characteristic of a cylindrical columnar body made of silicon nitride (SiN) having a height of 500 nm. Characteristic C3 is a characteristic of a cylindrical columnar body made of silicon dioxide (SiO₂) having a height of 2 μm.

The diameter of each columnar body 17a is determined from the characteristics shown in FIG. 9 so that the maximum phase delay amount shown in FIG. 8 is obtained. As a result, the diameter of the columnar body 17a at each position x is determined as shown in FIG. 10. The horizontal axis in FIG. 10 indicates the position x (unit: mm), and the vertical axis in FIG. 10 indicates the diameter of the columnar body 17a (unit: nm). FIG. 10 shows the diameter of the columnar body 17a at each position x for each constituent material shown in FIG. 9. Graph PS1 shows the diameter of the columnar body 17a at each position x when the constituent material indicated by characteristic C1 is used. Graph PS2 shows the diameter of the columnar body 17a at each position x when the constituent material indicated by characteristic C2 is used. Graph PS3 shows the diameter of the columnar body 17a at each position x when the constituent material indicated by characteristic C3 is used.

The maximum phase delay amount shown in FIG. 8 becomes 0 radians when the position x is −3.2 mm. Therefore, for the position x of −3.2 mm or less, the diameter of the columnar body 17a at each position x is determined based on the diameter at 2π radians in the characteristics shown in FIG. 9. If there is no diameter that provides the maximum phase delay amount at a certain position, the columnar body 17a need not be provided at that position. Alternatively, a columnar body 17a with a diameter that provides a phase delay amount closest to the maximum phase delay amount may be provided.

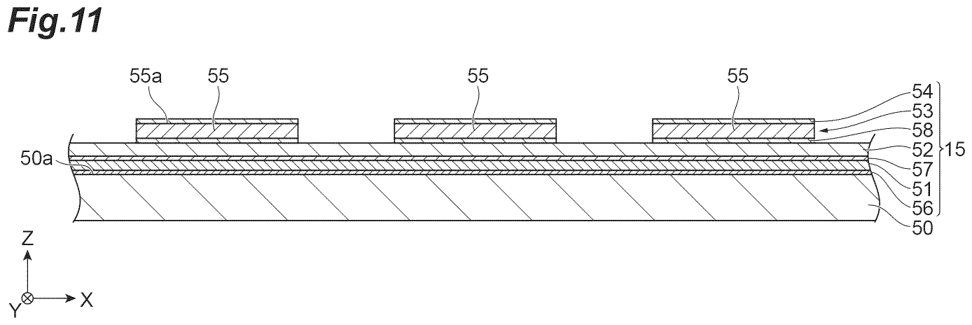

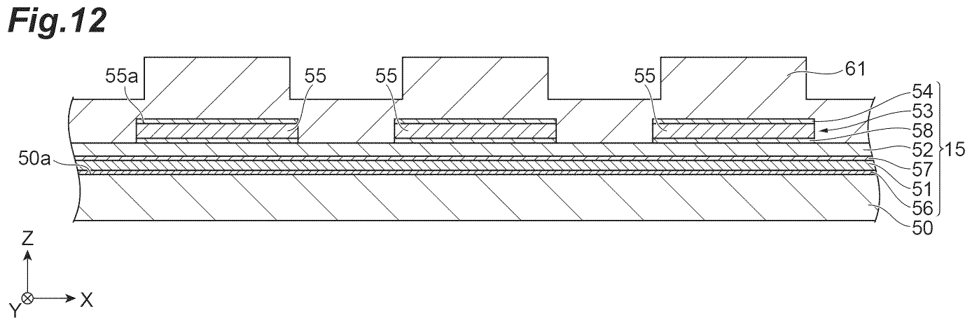

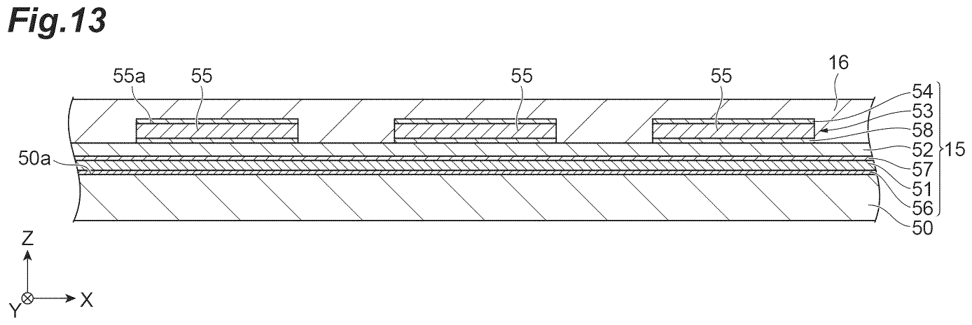

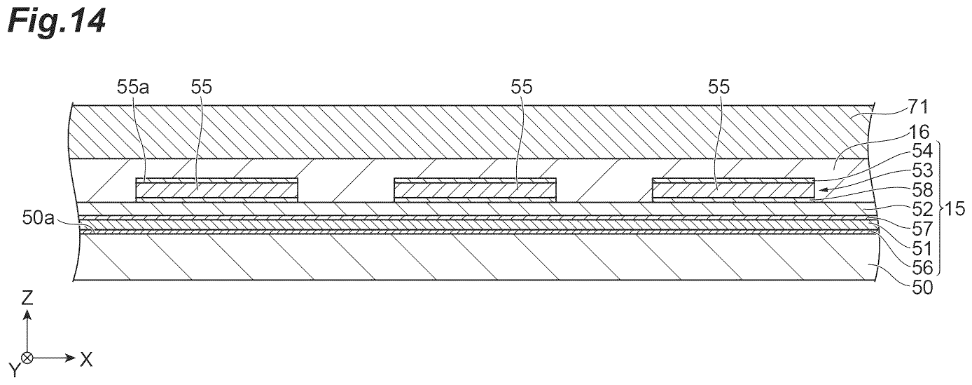

Next, a method for manufacturing the reflector 14 will be described with reference to FIGS. 11 to 14. FIG. 11 is a diagram for explaining the formation of the reflective layer. FIG. 12 is a diagram for explaining the formation of the dielectric layer. FIG. 13 is a diagram for explaining the planarization of the dielectric layer. FIG. 14 is a diagram for explaining the formation of the light-transmitting layer.

First, a base material 50 is prepared, and the base material 50 is set in a vacuum film deposition device. Then, the metal layer 51 is formed in a desired area on a surface 50a of the base material 50. Specifically, the metal layer 51 is formed by vacuum film deposition using a technique such as a direct current (DC) sputtering. For forming the metal layer 51, a metal material made of any metal selected from the group consisting of gold (Au), copper (Cu), silver (Ag), and aluminum (Al), or a metal alloy containing at least one element selected from the above-described group is used.

In order to enhance the adhesion between the surface 50a of the base material 50 and the metal layer 51, the adhesion layer 56 may be formed on the surface 50a, and the metal layer 51 may be formed on the adhesion layer 56. The adhesion layer 56 is formed, for example, by sputtering or vapor deposition. For forming the adhesion layer 56, for example, chromium (Cr) is used. The length (film thickness) of the adhesion layer 56 in the Z-axis direction is, for example, 3 nm.

Subsequently, the dielectric layer 52 is formed on the metal layer 51. Specifically, the dielectric layer 52 is formed by vacuum film deposition using a technique such as a radio frequency (RF) sputtering. For forming the dielectric layer 52, a dielectric material such as silicon dioxide (SiO₂), titanium oxide (TiO₂), magnesium oxide (MgO), or aluminum oxide (Al₂O₃) that can be formed by a semiconductor process is used.

In order to enhance the adhesion between the metal layer 51 and the dielectric layer 52, the adhesion layer 57 may be formed on the metal layer 51, and the dielectric layer 52 may be formed on the adhesion layer 57. Since the method for forming the adhesion layer 57 is the same as the method for forming the adhesion layer 56, a detailed description thereof will be omitted. For forming the adhesion layer 57, for example, chromium (Cr) is used.

Subsequently, a metal layer which is a base of the metal layer 53 is formed on the dielectric layer 52. Since the method for forming the metal layer which is a base of the metal layer 53 is the same as the method for forming the metal layer 51, a detailed description thereof will be omitted. For forming the metal layer which is a base of the metal layer 53, a metal material made of any metal selected from the group consisting of copper (Cu), silver (Ag), and aluminum (Al), or a metal alloy containing at least one element selected from the above-described group is used.

In order to enhance the adhesion between the dielectric layer 52 and the metal layer which is a base of the metal layer 53, an adhesion layer which is a base of the adhesion layer 58 may be formed on the dielectric layer 52, and the metal layer which is a base of the metal layer 53 may be formed on the adhesion layer. Since the method for forming the adhesion layer is the same as the method for forming the adhesion layer 56, a detailed description thereof will be omitted. For forming the adhesion layer, chromium (Cr) is used, for example.

Subsequently, a metal layer (hereinafter, sometimes referred to as an “outermost metal layer”) which is a base of the protective layer 54 is formed on the metal layer which is a base of the metal layer 53. Since the method for forming the outermost metal layer is the same as the method for forming the metal layer 51, a detailed description thereof will be omitted. For forming the outermost metal layer, a metal material made of any metal selected from the group consisting of gold (Au), ruthenium (Ru), and iridium (Ir), or a metal alloy containing at least one element selected from the above-described group.

Subsequently, the metal layer 53 (the plurality of metal bodies 55) and the protective layer 54 are formed by a photolithography process and an etching process. Specifically, a liquid resist is applied onto the outermost metal layer using a spin coater or the like, and the applied liquid resist is dried to form a resist film (photoresist). Then, a pattern corresponding to the metal bodies 55 is transferred onto the resist film using an exposure device such as a KrF exposure device and an electron beam lithography device.

Then, the pattern transferred to the resist film is developed using a developing machine. Then, portions of the metal layer which is a base of the metal layer 53 and the outermost metal layer not covered with the pattern are removed by ion milling, and then the resist film is removed with an organic solvent (NMP). Thus, the metal layer 53 and the protective layer 54 are formed. As described above, the reflective layer 15 is formed on the base material 50 as shown in FIG. 11.

Subsequently, as shown in FIG. 12, a dielectric layer 61 which is a base of the dielectric spacer layer 16 is formed on the reflective layer 15. Since the method for forming the dielectric layer 61 is the same as the method for forming the dielectric layer 52, a detailed description thereof will be omitted. The film thickness of the dielectric layer 61 is, for example, 80 nm.

Subsequently, as shown in FIG. 13, the dielectric layer 61 is planarized by a chemical mechanical polishing (CMP) process. Although it is ideal that the dielectric layer 61 on the protective layer 54 is completely removed, it is sufficient that the dielectric layer 61 is planarized. As a result, the dielectric spacer layer 16 is formed. The distance from the upper surface of the protective layer 54 to the upper surface of the dielectric spacer layer 16, that is, the film thickness of the dielectric spacer layer 16 on the metal body 55, is 0 nm to 50 nm.

Subsequently, as shown in FIG. 14, a light-transmitting layer 71 which is a base of the phase correction layer 17 is formed on the dielectric spacer layer 16. The light-transmitting layer 71 is a layer made of a material having visible light transparency. The thickness of the light-transmitting layer 71 is substantially equal to the height of the columnar bodies 17a.

Subsequently, the phase correction layer 17 is formed by a photolithography process and an etching process. Specifically, a metal layer is formed by vacuum film deposition using a technique such as a direct current (DC) sputtering. Then, a liquid resist is applied onto the metal layer using a spin coater or the like, and the applied liquid resist is dried to form a resist film (photoresist). Then, a resist pattern corresponding to the columnar bodies 17a is transferred onto the resist film using an exposure device such as a KrF exposure device and an electron beam lithography device.

Then, the resist pattern transferred onto the resist film is developed using a developing machine. Then, by an etching process, a portion of the metal layer not covered with the resist pattern is removed, and then the resist pattern is removed. As a result, a metal mask is formed on the light-transmitting layer 71. Then, by an etching process, a portion of the light-transmitting layer 71 not covered with the metal mask is etched to a depth corresponding to the height of the columnar bodies 17a. Thereafter, the metal mask is removed. As a result, the phase correction layer 17 is formed.

As described above, the reflector 14 is formed on the surface 50a of the base material 50 (refer to FIG. 4).

By the above-described method, a plurality of reflectors 14 are formed on one base material 50. Therefore, by cutting the base material 50, a portion including one reflector 14 is obtained. Then, by attaching the base material 50 of the portion to a predetermined area of the inner surface 3a of the lens 3, the reflector 14 is formed on the inner surface 3a of the lens 3.

The reflector 14 may be formed directly on the inner surface 3a of the lens 3. The method for forming the reflector 14 on the inner surface 3a of the lens 3 is the same as the method for forming the reflector 14 on the surface 50a of the base material 50. In this case, the reflector 14 is formed in a desired area on the inner surface 3a.

In the retinal projection device 10 described above, the laser light Ls is reflected as reflected light Lref by the reflective layer 15 at a reflection angle θᵣ that changes depending on the wavelength of the laser light Ls, and the chromatic aberration of the reflected light Lref is corrected by the phase correction layer 17. Therefore, chromatic aberration can be reduced.

In order to correct chromatic aberration, it is conceivable to provide a correction lens in the optical path of the laser light Ls. In this case, the number of components of the retinal projection device increases. In contrast, in the retinal projection device 10, since the reflective layer 15 and the phase correction layer 17 are integrally formed, there is no need to add external components.

The phase correction layer 17 is a metalens including the plurality of columnar bodies 17a having visible light transparency. According to this configuration, when visible light passes through each columnar body 17a, a phase delay of the visible light occurs in accordance with the size of the columnar body 17a. Therefore, by appropriately adjusting the phase delay amount occurring in each columnar body 17a, chromatic aberration can be reduced.

The phase correction layer 17 may be made of one compound selected from the group consisting of silicon oxides, titanium oxides, tantalum oxides, and silicon nitrides. Since these compounds are transparent in the visible light region, the visible light transparency of the phase correction layer 17 can be realized. Since absorption of visible light in the phase correction layer 17 is suppressed, reflection efficiency for visible light can be enhanced.

The size of each columnar body 17a is set such that the phase of the red light Lr and the phase of the blue light Lb are in phase at the position where the columnar body 17a is provided. The maximum wavelength λₘₐₓ of the operating wavelength band in the retinal projection device 10 is the wavelength λ_{red} of the red light Lr, and the minimum wavelength λₘᵢₙ of the operating wavelength band is the wavelength λ_{blue} of the blue light Lb. For this reason, by making the phase of the red light Lr and the phase of the blue light Lb in phase, the maximum phase delay amount occurring in the operating wavelength band can be eliminated. This makes it possible to reduce chromatic aberration.

The reflective layer 15 is a metamirror including a plurality of nanostructures (unit regions 40) provided along the inner surface 3a of the lens 3. Each nanostructure includes the metal layer 51, the dielectric layer 52, and the metal body 55 sequentially stacked in a direction intersecting (orthogonal to) the inner surface 3a. According to this configuration, the reflective layer 15 can function as a reflective mirror due to electromagnetic resonance between the metal layer 51 and the metal body 55.

The reflective layer 15 is configured such that a predetermined reflection angle θᵣ is obtained for the reference wavelength λ_{ref}. Since the reflection angle θᵣ at the reflective layer 15 changes depending on the wavelength λ, the length Lx (the length of the metal body 55 in the X-axis direction) can be set by using the reference wavelength λ_{ref}.

The reference wavelength λ_{ref} may be the wavelength λ_{red} of the red light Lr. In this case, since the length Lx (the length of the metal body 55 in the X-axis direction) can be increased, the manufacturing of the reflector 14 can be facilitated.

The reflector 14 includes the dielectric spacer layer 16 provided between the reflective layer 15 and the phase correction layer 17. In this case, by providing the dielectric spacer layer 16, a surface planarization process such as CMP can be performed to planarize the surface of the dielectric spacer layer 16.

The dielectric spacer layer 16 may be made of one compound selected from the group consisting of silicon oxides, titanium oxides, tantalum oxides, and silicon nitrides. In this case, by using a material having a refractive index that is the same as or close to the refractive index of the phase correction layer 17, unnecessary interface reflection can be suppressed.

The retinal projection device according to the present disclosure is not limited to the above-described embodiments.

The method for determining the length Lx is not limited to the method described in the above-described embodiments. For example, the lengths Lx of the unit regions 40 located at both ends of the reflector 14 in the X-axis direction may be determined by the above-described method, and the lengths Lx of the unit regions 40 located therebetween may be determined so as to gradually change from the length Lx of the unit region 40 located at one end of the reflector 14 in the X-axis direction to the length Lx of the unit region 40 located at the other end thereof.

The metal body 55 is not limited to a single metal body having a trapezoidal shape, and may be composed of, for example, a plurality of metal bodies arranged in the X-axis direction.

The metal layer 51 and the metal body 55 may be made of a transparent conductor. In other words, each nanostructure of the reflective layer 15 may include a first transparent conductive layer and a second transparent conductive layer instead of the metal layer 51 and the metal body 55. Each transparent conductive layer has excellent electrical conductivity and high transparency in the visible light region. An example of a constituent material of the transparent conductive layer is a transparent conductive oxide (TCO). Examples of TCO include indium tin oxide (ITO), indium zinc oxide (IZO), fluorine-doped tin oxide (FTO), and aluminum-doped zinc oxide (AZO). Also in this case, similarly to the metal layer 51 and the metal body 55, the reflective layer 15 can function as a reflective mirror due to electromagnetic resonance between the first transparent conductive layer and the second transparent conductive layer. Furthermore, by using the transparent conductive layers, it is possible to reduce a possibility that a field of view is obstructed, and it is possible to improve visibility.

### ADDITIONAL STATEMENTS

### Clause 1

A retinal projection device to be mounted on a near-eye wearable device, the retinal projection device comprising:
a light source configured to emit laser light;
a movable mirror configured to perform scanning with the laser light; and
a reflector configured to project an image onto a retina of a user wearing the near-eye wearable device by reflecting the laser light having passed through the movable mirror and irradiating the retina with reflected light,
wherein the reflector includes:
   a reflective layer configured to reflect the laser light at a reflection angle that changes depending on a wavelength of the laser light and to emit the laser light as the reflected light; and
   a phase correction layer configured to correct chromatic aberration of the reflected light.

### Clause 2

The retinal projection device according to clause 1,
wherein the phase correction layer is a metalens including a plurality of columnar bodies having visible light transparency.

### Clause 3

The retinal projection device according to clause 2,
wherein the phase correction layer is made of one compound selected from a group consisting of silicon oxides, titanium oxides, tantalum oxides, and silicon nitrides.

### Clause 4

The retinal projection device according to clause 2 or 3,
wherein a size of each of the plurality of columnar bodies is set such that, at a position where a respective columnar body is provided, a phase of red light and a phase of blue light are in phase.

### Clause 5

The retinal projection device according to any one of clauses 1 to 4,
wherein the reflective layer is a metamirror including a plurality of nanostructures provided along a surface of a lens of the near-eye wearable device, the surface facing an eyeball of the user, and
wherein each of the plurality of nanostructures includes a metal layer, a dielectric layer, and a metal body sequentially stacked in a direction intersecting the surface.

### Clause 6

The retinal projection device according to any one of clauses 1 to 4,
wherein the reflective layer is a metamirror including a plurality of nanostructures provided along a surface of a lens of the near-eye wearable device, the surface facing an eyeball of the user, and
wherein each of the plurality of nanostructures includes a first transparent conductive layer, a dielectric layer, and a second transparent conductive layer sequentially stacked in a direction intersecting the surface.

### Clause 7

The retinal projection device according to clause 6,
wherein first transparent conductive layer and the second transparent conductive layer are made of ITO.

### Clause 8

The retinal projection device according to any one of clauses 5 to 7,
wherein the reflective layer is configured such that a predetermined reflection angle is obtained for a reference wavelength.

### Clause 9

The retinal projection device according to clause 8,
wherein the reference wavelength is a wavelength of red light contained in the laser light.

### Clause 10

The retinal projection device according to any one of clauses 1 to 9,
wherein the reflector further includes a dielectric spacer layer provided between the reflective layer and the phase correction layer.

### Clause 11

The retinal projection device according to clause 10,
wherein the dielectric spacer layer is made of one compound selected from a group consisting of silicon oxides, titanium oxides, tantalum oxides, and silicon nitrides.

What is claimed is:

1. A retinal projection device to be mounted on a near-eye wearable device, the retinal projection device comprising:
a light source configured to emit laser light;
a movable mirror configured to perform scanning with the laser light; and
a reflector configured to project an image onto a retina of a user wearing the near-eye wearable device by reflecting the laser light having passed through the movable mirror and irradiating the retina with reflected light,
wherein the reflector includes:
a reflective layer configured to reflect the laser light at a reflection angle that changes depending on a wavelength of the laser light and to emit the laser light as the reflected light; and
a phase correction layer configured to correct chromatic aberration of the reflected light.

2. The retinal projection device according to claim 1,
wherein the phase correction layer is a metalens including a plurality of columnar bodies having visible light transparency.

3. The retinal projection device according to claim 2,
wherein the phase correction layer is made of one compound selected from a group consisting of silicon oxides, titanium oxides, tantalum oxides, and silicon nitrides.

4. The retinal projection device according to claim 2,
wherein a size of each of the plurality of columnar bodies is set such that, at a position where a respective columnar body is provided, a phase of red light and a phase of blue light are in phase.

5. The retinal projection device according to claim 2,
wherein each of the plurality of columnar bodies is set to a size at which a maximum phase delay amount in an operating wavelength band is obtained at a position where a respective columnar body is provided.

6. The retinal projection device according to claim 5,
wherein the plurality of columnar bodies have a cylindrical shape with a same height, and
a diameter of each of the plurality of columnar bodies is set so as to obtain the maximum phase delay amount in the operating wavelength band at the position where the respective columnar body is provided.

7. The retinal projection device according to claim 5,
wherein the maximum phase delay amount obtained by the plurality of columnar bodies changes linearly in a direction intersecting the columnar bodies.

8. The retinal projection device according to claim 1,
wherein the reflective layer is a metamirror including a plurality of nanostructures provided along a surface of a lens of the near-eye wearable device, the surface facing an eyeball of the user, and
wherein each of the plurality of nanostructures includes a metal layer, a dielectric layer, and a metal body sequentially stacked in a direction intersecting the surface.

9. The retinal projection device according to claim 1,
wherein the reflective layer is a metamirror including a plurality of nanostructures provided along a surface of a lens of the near-eye wearable device, the surface facing an eyeball of the user, and
wherein each of the plurality of nanostructures includes a first transparent conductive layer, a dielectric layer, and a second transparent conductive layer sequentially stacked in a direction intersecting the surface.

10. The retinal projection device according to claim 9,
wherein first transparent conductive layer and the second transparent conductive layer are made of ITO.

11. The retinal projection device according to claim 8,
wherein the reflective layer is configured such that a predetermined reflection angle is obtained for a reference wavelength.

12. The retinal projection device according to claim 11,
wherein the reference wavelength is a wavelength of red light contained in the laser light.

13. The retinal projection device according to claim 11,
wherein the reference wavelength is a wavelength of blue light contained in the laser light.

14. The retinal projection device according to claim 8,
wherein each of the plurality of nanostructures further includes a protective layer configured to protect the metal body.

15. The retinal projection device according to claim 14,
wherein the protective layer is made of a metal having a standard electrode potential higher than that of a metal constituting the metal body.

16. The retinal projection device according to claim 1,
wherein the reflector further includes a dielectric spacer layer provided between the reflective layer and the phase correction layer.

17. The retinal projection device according to claim 16,
wherein the dielectric spacer layer is made of one compound selected from a group consisting of silicon oxides, titanium oxides, tantalum oxides, and silicon nitrides.

18. The retinal projection device according to claim 16,
wherein the dielectric spacer layer absorbs a difference in refractive index between the reflective layer and the phase correction layer.

19. The retinal projection device according to claim 16,
wherein the dielectric spacer layer is made of a material that is transparent in a visible light region.

20. A near-eye wearable device comprising:
the retinal projection device according to claim 1; and
a lens on which the reflective layer is provided.
